(19) United States
(12) Patent Application Publication
(10) Pub. No.: US 2026/0243324 A1
(43) Pub. Date: Aug. 20, 2026

(54) SPRING ASSEMBLY, CAMERA MODULE, AND ELECTRONIC DEVICE

(71) Applicant: TOPPAN Holdings Inc., Tokyo (JP)

(72) Inventors: Tatsuya KASHIO, Tokyo (JP); Osamu KOGA, Tokyo (JP)

(73) Assignee: TOPPAN Holdings Inc., Tokyo (JP)

(21) Appl. No.: 19/642,772

(22) Filed: Apr. 9, 2026

Related U.S. Application Data
(63) Continuation of application No. PCT/JP2025/021428, filed on Jun. 13, 2025.

(30) Foreign Application Priority Data
Jun. 13, 2024 (JP) 2024-095885

(51) Int. Cl. F16F 3/02; G03B 5/02

(52) U.S. Cl. CPC F16F 3/023; G03B 5/02

(57) ABSTRACT

A first edge portion includes, in a second direction, a first bottom portion, a first top portion, and a second bottom portion located between a first end portion and a second end portion. In the second direction, the first top portion is located between the first bottom portion and the second bottom portion. In a first direction, the distance between a central axis of an inner spring extending along the second direction and the first top portion is shorter than at least one of a distance between the central axis and the first end portion, and the distance between the central axis and the second end portion. In the first direction, the distance between the central axis and the first top portion is longer than the distance between the central axis and the first bottom portion and a distance between the central axis and the second bottom portion.

### CROSS-REFERENCE TO RELATED APPLICATIONS

This application is a bypass continuation application of international application No. PCT/JP2025/021428, filed Jun. 13, 2025, which claims priority from Japanese Patent Application No. 2024-095885, filed Jun. 13, 2024, the entire contents of each of which are incorporated herein by reference.

### TECHNICAL FIELD

The present disclosure relates to a spring assembly, a camera module, and an electronic device.

### BACKGROUND ART

Camera modules included in electronic devices equipped with cameras, such as tablet terminals and smartphones, are provided with a drive mechanism to enable autofocus and zoom functions. As drive mechanisms, a lens-driving method and a sensor-driving method are known. A drive mechanism using the lens-driving method includes a spring assembly that makes it possible to change the position of a lens in the optical axis direction of the lens. In contrast, a drive mechanism using the sensor-driving method includes a spring assembly that makes it possible to change the position of an image sensor in the optical axis direction of the lens (for example, see PTL 1 and 2).

### CITATION LIST

### Patent Literature

PTL 1: JP 2014-059345 A

PTL 2: JP 2020-170170 A

### SUMMARY OF INVENTION

### Problem to be Solved

In the spring included in a spring assembly, enhancement of the uniformity of the spring width in a thickness direction is being sought.

### Solution to Problem

A spring assembly for solving the problem described above includes:
a first surface;
a second surface opposite to the first surface; and,
in a cross-section orthogonal to the first surface, a plurality of springs arranged side-by-side along a first direction, the plurality of springs including a pair of outer springs, and an inner spring interposed between the outer springs in the first direction. A direction orthogonal to the first direction is a second direction. The inner spring includes a first edge portion and a second edge portion that face each other in the first direction. The first edge portion includes
a first end portion located on the first surface,
a second end portion located on the second surface, and,
in the second direction, a first bottom portion, a first top portion, and a second bottom portion located between the first end portion and the second end portion. In the second direction, the first top portion is located between the first bottom portion and the second bottom portion. In the first direction, a distance between a central axis of the inner spring extending along the second direction and the first top portion is shorter than at least one of a distance between the central axis and the first end portion, and a distance between the central axis and the second end portion. In the first direction, the distance between the central axis and the first top portion is longer than a distance between the central axis and the first bottom portion and a distance between the central axis and the second bottom portion.

The spring assembly is formed by wet etching a metal foil for the spring assembly from both the first surface and the second surface. Because the wet etching of the metal foil proceeds isotropically, the first edge portion and the second edge portion of the inner spring formed in the metal foil by wet etching have an arc shape with a center of curvature located outside the inner spring. Therefore, the inner spring has a constricted shape between the first surface and the second surface. As a result, the difference between the spring width at each surface and the spring width at the constricted section tends to increase. In this respect, according to the spring assembly described above, because the first edge portion of the inner spring has the first bottom portion, the first top portion, and the second bottom portion, it is possible to reduce the amount of constriction at each bottom portion compared to a case where the inner spring becomes constricted at a single location in the thickness direction. This makes it possible to enhance the uniformity of the spring width in the thickness direction of the inner spring. The expression “constricted shape” refers to the case in which the width of the spring member along the first direction is narrower at a position between the first surface and the second surface than at the surfaces (i.e., the first surface and the second surface).

The spring assembly described above may be configured such that the second edge portion includes: a third end portion located on the first surface; a fourth end portion located on the second surface; and, in the second direction, a third bottom portion, a second top portion, and a fourth bottom portion located between the third end portion and the fourth end portion, in the second direction, the second top portion is located between the third bottom portion and the fourth bottom portion, in the first direction, a distance between the central axis extending along the second direction and the second top portion is shorter than at least one of a distance between the central axis and the third end portion, and a distance between the central axis and the fourth end portion, and in the first direction, the distance between the central axis and the second top portion is longer than a distance between the central axis and the third bottom portion and a distance between the central axis and the fourth bottom portion.

According to the spring assembly described above, in addition to the first edge portion, the second edge portion has the third bottom portion, the second top portion, and the fourth bottom portion, which makes it possible to further enhance the uniformity of the thickness of the inner spring compared to a case where only the first edge portion includes two bottom portions and a top portion interposed between the two bottom portions.

The spring assembly described above may be configured such that, in the second direction, a distance between the first top portion and the second top portion is shorter than a distance between the first top portion and the third bottom portion and a distance between the first top portion and the fourth bottom portion.

According to the spring assembly described above, the inner spring tends to have a local maximum value of the spring width between the first top portion and the second top portion in the second direction. This reduces the risk of the inner sprint having a constricted shape at only one location in the thickness direction, which suppresses variations in the spring width in the thickness direction of the inner spring.

The spring assembly described above may be configured such that, in the second direction, the distance between the first top portion and the second top portion is shorter than a distance between the second top portion and the first bottom portion and a distance between the second top portion and the second bottom portion.

The spring assembly described above may be configured such that a width of the inner spring along the first direction has a local maximum value at the first top portion, the second top portion, or between the first top portion and the second top portion in the second direction.

The spring assembly described above may be configured such that, in the second direction, the width of the inner spring has a first local minimum value between the first end portion and the first top portion, and has a second local minimum value between the second end portion and the first top portion, and a percentage of the first local minimum value with respect to the local maximum value and a percentage of the second local minimum value with respect to the local maximum value are each 66% or more.

According to the spring assembly described above, because the outer shape of the inner spring approaches a rectangular shape, it is possible to increase the strength of the inner spring.

The spring assembly described above may be configured such that, in the second direction, the width of the inner spring has a first local minimum value between the first end portion and the first top portion, and has a second local minimum value between the second end portion and the first top portion, and in the second direction, a percentage of a distance between the local maximum value and the first local minimum value with respect to the thickness of the inner spring and a percentage of a distance between the local maximum value and the second local minimum value with respect to the thickness of the inner spring are each 24% or less.

According to the spring assembly described above, because the position at which the width along the first direction becomes narrow in the inner spring approaches the first top portion, it is possible to enhance the resistance of the inner spring to deformation.

The spring assembly described above may be configured such that, in the second direction, the width of the inner spring has a first local minimum value between the first end portion and the first top portion, and has a second local minimum value between the second end portion and the first top portion, and in the second direction, a percentage of a distance between the first local minimum value and the second local minimum value with respect to a thickness of the inner spring is 39% or more and 46% or less.

According to the spring assembly described above, because biasing in the shape of the inner spring is less likely to occur in the second direction, it is possible to further enhance the strength of the inner spring.

The spring assembly described above may be configured such that a thickness of the inner spring is 150 μm or more. Generally, the thicker the metal foil, the more the erosion of the metal foil progresses along the width direction of the spring when the metal foil is subjected to wet etching, and the constriction of the inner spring tends to become significant. In this respect, according to the spring assembly described above, even when a thick spring with a thickness of 150 μm or more is manufactured by wet etching a metal foil, an increase in the difference between the minimum value and the maximum value of the spring width in the thickness direction is suppressed.

The spring assembly described above may be configured such that a pitch of the plurality of springs is 100 μm or more and 200 μm or less, and a maximum value of a width of each spring along the first direction is one-half of the pitch or less.

According to the spring assembly described above, in the vicinity of the springs, the etching amount of the metal foil becomes large enough to etch at least half of the metal foil in the first direction, and the constriction of the inner spring tends to become significant. Therefore, the effect of the inner spring having the first edge portion can be significantly obtained.

The spring assembly described above may be configured such that the spring assembly comprises a base material including at least one material selected from a group consisting of stainless alloy, beryllium copper, nickel-tin copper, phosphor bronze, Corson alloy, and titanium copper, the base material is provided with a first surface, and a second surface located opposite to the first surface of the base material, and the spring assembly further comprises a copper layer on at least one of the first surface of the base material and the second surface of the base material.

A camera module for solving the above problem includes the spring assembly described above. An electronic device for solving the above problem includes the camera module described above.

### Advantageous Effects of the Invention

According to the spring assembly of the present disclosure, it is possible to enhance the uniformity in the spring width in the thickness direction of an inner spring.

### BRIEF DESCRIPTION OF THE DRAWINGS

FIG. 1 is a plan view showing the structure of a spring assembly of an embodiment.

FIG. 2 is a cross-sectional view showing the structure along line II-II shown in FIG. 1.

FIG. 3 is a cross-sectional view showing the structure of an inner spring included in the spring assembly shown in FIG. 2.

FIG. 4 is a process diagram showing a step of a method of manufacturing the spring assembly.

FIG. 5 is a process diagram showing a step of a method of manufacturing the spring assembly.

FIG. 6 is a process diagram showing a step of a method of manufacturing the spring assembly.

FIG. 7 is a process diagram showing a step of a method of manufacturing the spring assembly.

FIG. 8 is a process diagram showing a step of a method of manufacturing the spring assembly.

FIG. 9 is a process diagram showing a step of a method of manufacturing a spring assembly in Test Example 3.

FIG. 10 is a process diagram showing a step of a method of manufacturing a spring assembly in Test Example 3.

FIG. 11 is a process diagram showing a step of a method of manufacturing a spring assembly in Test Example 3.

FIG. 12 is a process diagram showing a step of a method of manufacturing a spring assembly in Test Example 5.

FIG. 13 is a process diagram showing a step of a method of manufacturing a spring assembly in Test Example 5.

FIG. 14 is a process diagram showing a step of a method of manufacturing a spring assembly in Test Example 5.

FIG. 15 is a table showing the evaluation results of Test Example 1.

FIG. 16 is a table showing the evaluation results of Test Example 2.

FIG. 17 is a table showing the evaluation results of Test Example 3.

FIG. 18 is a table showing the evaluation results of Test Example 4.

FIG. 19 is a table showing the analysis results of Test Example 1.

FIG. 20 is a table showing the analysis results of Test Example 2.

FIG. 21 is a table showing the analysis results of Test Example 3.

FIG. 22 is a table showing the analysis results of Test Example 4.

### DESCRIPTION OF EMBODIMENT

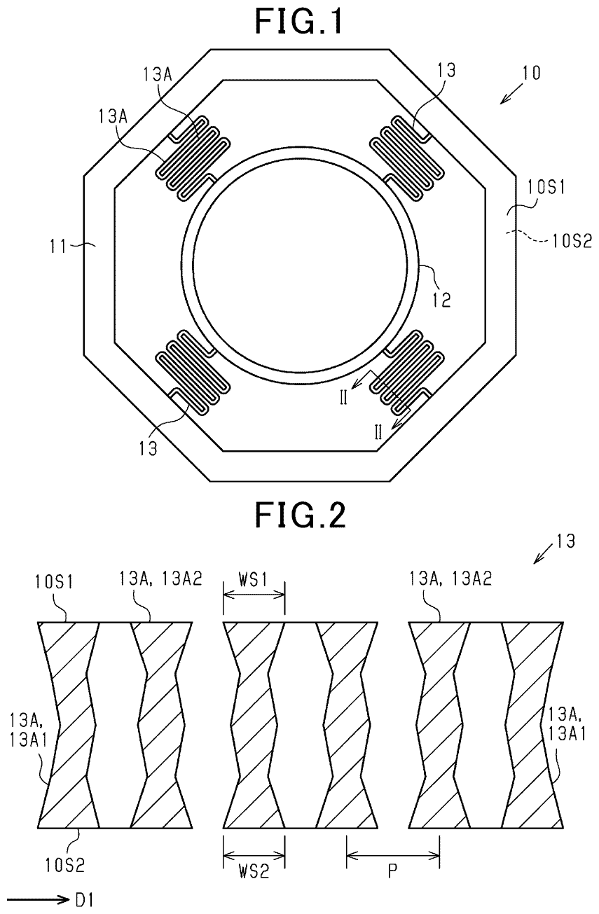

An embodiment of a spring assembly will be described with reference to FIGS. 1 to 22.

### Spring Assembly

The spring assembly will be described with reference to FIGS. 1 to 3.

As shown in FIG. 1, a spring assembly 10 for a camera module includes a first surface 10S1, and a second surface 10S2 opposite to the first surface 10S1. The spring assembly 10 includes an outer frame portion 11, an inner frame portion 12, and spring portions 13. The spring portion 13 is a leaf spring.

The spring portion 13 includes a plurality of springs 13A. Each spring 13A has a linear shape extending along a plane in which the spring assembly 10 extends, when viewed from a viewpoint facing the plane in which the spring assembly 10 extends. Each spring 13A is a portion of a metal foil forming the spring assembly 10, and adjacent springs 13A are connected to each other by bend portions.

In the example shown in FIG. 1, the outer shape of the outer frame portion 11 has an octagonal shape, and the outer shape of the inner frame portion 12 has a circular shape. The spring portion 13 has a zigzag shape. The outer shape of the outer frame portion 11 and the outer shape of the inner frame portion 12 may be changed according to the shapes of other assemblies included in a drive mechanism of the camera module on which the spring assembly 10 is mounted, that is, assemblies other than the spring assembly 10. The spring portion 13 may have a structure in which a single wire has a plurality of bends, making it appear as if a plurality of springs 13A are arranged side-by-side, or may have a plurality of mutually independent springs 13A, with the springs 13A being arranged side-by-side. The inner frame portion 12 is located within a region defined by the outer frame portion 11. The spring portion 13 connects the inner frame portion 12 to the outer frame portion 11.

In a drive mechanism using the lens-driving method, the spring assembly 10 may be disposed on one surface of a lens in the optical axis direction of the lens. Alternatively, two spring assemblys 10 may be disposed so as to sandwich the lens in the optical axis direction of the lens. A change in the position of the inner frame portion 12 connected to each outer frame portion 11 relative to the outer frame portion 11 in the optical axis direction causes a change in the position of the lens in the optical axis direction of the lens. This makes it possible to correct for camera shake using the drive mechanism of the lens-driving method.

In contrast, in a drive mechanism using the sensor-driving method, the spring assembly 10 may be disposed on one surface of an image sensor in the optical axis direction of a lens. Alternatively, two spring assemblys 10 may be disposed so as to sandwich the image sensor in the optical axis direction of the lens. A change in the position of the inner frame portion 12 connected to each outer frame portion 11, relative to the outer frame portion 11, in the optical axis direction, causes a change in the position of the image sensor in the optical axis direction of the lens. This makes it possible to correct for camera shake using the drive mechanism of the sensor-driving method.

The electronic device on which the camera module including the spring assembly 10 is mounted may be, for example, a mobile phone terminal, a smartphone, a tablet terminal, a notebook personal computer, or the like.

FIG. 2 shows a cross-sectional structure of the spring portion 13 along line II-II shown in FIG. 1. That is, FIG. 2 shows a cross-sectional structure of the spring assembly 10 along a plane orthogonal to the first surface 10S1 included in the spring assembly 10, and orthogonal to the direction in which each spring 13A extends.

As shown in FIG. 2, in a cross-section orthogonal to the first surface 10S1, the spring portion 13 includes three or more springs 13A. In such a cross-section, among the springs 13A, the springs 13A located at both ends in the direction in which the springs 13A are arranged side-by-side are outer springs 13A1. The direction in which the springs 13A are arranged side-by-side is a first direction D1. Among the plurality of springs 13A, the springs 13A interposed between the outer springs 13A1 in the first direction D1 are inner springs 13A2. That is, the spring portion 13 includes, in a cross-section orthogonal to the first surface 10S1, a plurality of springs 13A arranged side-by-side along the first direction D1. The plurality of springs 13A include a pair of outer springs 13A1, and inner springs 13A2 interposed between the outer springs 13A1 in the first direction D1.

In the example shown in FIG. 2, in a cross-section orthogonal to the first surface 10S1, the spring portion 13 includes six springs 13A. Therefore, in the first direction D1, four inner springs 13A2 are interposed between two outer springs 13A1. The plurality of springs 13A are arranged at substantially equal intervals in the first direction D1.

The width of each spring 13A on the first surface 10S1 is a first width WS1. The width of each spring 13A on the second surface 10S2 is a second width WS2. The inner spring 13A2 has a width of 10 μm or more on the first surface 10S1 and the second surface 10S2. The first width WS1 of the inner spring 13A2 is 10 μm or more, and the second width WS2 is 10 μm or more.

The outer spring 13A1 has a width identical to that of the inner spring 13A2 on the first surface 10S1 and the second surface 10S2. The outer spring 13A1 may have a width greater than that of the inner spring 13A2.

The thickness of the spring assembly 10 may be 150 μm or more. The thickness of the spring assembly 10 is the distance between the first surface 10S1 and the second surface 10S2. That is, the thickness of the inner spring 13A2 may be 150 μm or more.

In the direction in which the springs 13A are arranged side-by-side, the distance between the centers of the springs 13A is the pitch P of the springs 13A. The pitch P may be the distance between the centers of the springs 13A on the first surface 10S1, or the distance between the centers of the springs 13A on the second surface 10S2. In either case, the pitch P has an identical value. The pitch P may be, for example, 100 μm or more and 200 μm or less.

The spring assembly 10 is formed from a metal having a hardness high enough to achieve a spring load or deflection required of the spring assembly 10. The spring assembly 10 may be formed from, for example, a stainless alloy or a copper alloy. The stainless alloy may be, for example, a stainless alloy specified in JIS G 4313:2011 “Stainless steel strips for springs”. The copper alloy may be, for example, a copper alloy specified in JIS H 3130:2018 “Beryllium copper, titanium copper, phosphor bronze, nickel-tin copper and nickel silver sheets, plates and strips for springs”.

The spring assembly 10 may include at least one material selected from a group consisting of stainless alloy, beryllium copper, nickel-tin copper, phosphor bronze, Corson alloy, and titanium copper. The spring assembly 10 is preferably formed from at least one material selected from the above group. Since the spring assembly 10 can have high hardness, it is possible to enhance the durability of the spring assembly 10.

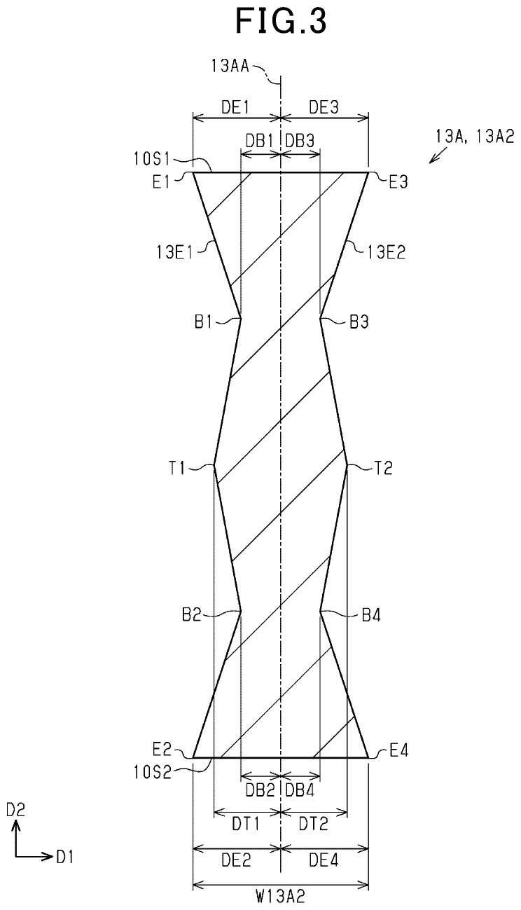

FIG. 3 shows an enlarged cross-sectional structure of one of the inner springs 13A2 included in the spring assembly 10. In the example shown in FIG. 3, the inner spring 13A2 has a line-symmetrical shape with a central axis 13AA of the inner spring 13A2 as the axis of symmetry.

As shown in FIG. 3, a direction orthogonal to the first direction D1 is a second direction D2. The inner spring 13A2 includes a first edge portion 13E1 and a second edge portion 13E2 that face each other in the first direction D1.

The first edge portion 13E1 includes a first end portion E1 located on the first surface 10S1, a second end portion E2 located on the second surface 10S2, and, in the second direction D2, a first bottom portion B1, a first top portion T1, and a second bottom portion B2 located between the first end portion E1 and the second end portion E2. In the second direction D2, the first top portion T1 is located between the first bottom portion B1 and the second bottom portion B2.

The first edge portion 13E1 has a zigzag shape with three bending points. The three bending points are the first bottom portion B1, the first top portion T1, and the second bottom portion B2. Of the first bottom portion B1 and the second bottom portion B2, the bottom portion with a shorter distance from the first end portion E1 is the first bottom portion B1, and the bottom portion with a shorter distance from the second end portion E2 is the second bottom portion B2.

In the example shown in FIG. 3, a first line segment connecting the first end portion E1 and the first bottom portion B1, a second line segment connecting the first bottom portion B1 and the first top portion T1, a third line segment connecting the first top portion T1 and the second bottom portion B2, and a fourth line segment connecting the second bottom portion B2 and the second end portion E2 all have a linear shape. At least one of the first line segment, the second line segment, the third line segment, and the fourth line segment may have a curved shape. When each line segment has a curved shape, each line segment may have an arc shape such that the center of curvature of the line segment is located outside the inner spring 13A2. That is, each line segment may have an arc shape that is recessed toward the central axis 13AA. Alternatively, each line segment may have an arc shape such that the center of curvature of the line segment is located inside the inner spring 13A2. That is, each line segment may have an arc shape that bulges in a direction away from the central axis 13AA.

The central axis 13AA of the inner spring 13A2 may be an axis that passes through the center of the inner spring 13A2 on the first surface 10S1 and extends along the second direction D2, or an axis that passes through the center of the inner spring 13A2 on the second surface 10S2 and extends along the second direction D2.

In the first direction D1, a distance DT1 between the central axis 13AA of the inner spring 13A2 extending along the second direction D2 and the first top portion T1 is shorter than a distance DE1 between the central axis 13AA and the first end portion E1, and a distance DE2 between the central axis 13AA and the second end portion E2. In the first direction D1, the distance DT1 between the central axis 13AA and the first top portion T1 is longer than a distance DB1 between the central axis 13AA and the first bottom portion B1, and a distance DB2 between the central axis 13AA and the second bottom portion B2.

In other words, in the first direction D1, the amount of protrusion of the first edge portion 13E1 with respect to the central axis 13AA at the first top portion T1 is smaller than the amount of protrusion with respect to the central axis 13AA at the first end portion E1 and the second end portion E2. Furthermore, in the first direction D1, the amount of protrusion of the first edge portion 13E1 with respect to the central axis 13AA at the first top portion T1 is larger than the amount of protrusion with respect to the central axis 13AA at the first bottom portion B1 and the second bottom portion B2.

The spring assembly 10 is formed by wet etching a metal foil for the spring assembly from both the first surface and the second surface. Because the wet etching of the metal foil proceeds isotropically, the first edge portion and the second edge portion of the inner spring formed in the metal foil by wet etching have an arc shape with a center of curvature located outside the inner spring. Therefore, the inner spring has a constricted shape between the first surface and the second surface. As a result, the difference between the spring width at each surface and the spring width at the constricted section tends to increase. In this respect, according to the spring assembly 10 of the present disclosure, because the first edge portion 13E1 of the inner spring 13A2 has the first bottom portion B1, the first top portion T1, and the second bottom portion B2, it is possible to reduce the amount of constriction at each of the bottom portions B1 and B2 compared to a case where the inner spring 13A2 becomes constricted at a single location in the thickness direction. This makes it possible to enhance the uniformity of the spring width in the thickness direction of the inner spring 13A2.

The distance DT1 may be, for example, 10 μm or more and 20 μm or less. The distance DE1 and the distance DE2 may be, for example, 16 μm or more and 25 μm or less. The distance DB1 and the distance DB2 may be, for example, 5 μm or more and 15 μm or less.

The second edge portion 13E2 includes a third end portion E3 located on the first surface 10S1, a fourth end portion E4 located on the second surface 10S2, and, in the second direction D2, a third bottom portion B3, a second top portion T2, and a fourth bottom portion B4 located between the third end portion E3 and the fourth end portion E4. In the second direction D2, the second top portion T2 is located between the third bottom portion B3 and the fourth bottom portion B4.

The second edge portion 13E2 has a zigzag shape with three bending points. The three bending points are the third bottom portion B3, the second top portion T2, and the fourth bottom portion B4. Of the third bottom portion B3 and the fourth bottom portion B4, the bottom portion with a shorter distance from the third end portion E3 is the third bottom portion B3, and the bottom portion with a shorter distance from the fourth end portion E4 is the fourth bottom portion B4.

In the example shown in FIG. 3, a first line segment connecting the third end portion E3 and the third bottom portion B3, a second line segment connecting the third bottom portion B3 and the second top portion T2, a third line segment connecting the second top portion T2 and the fourth bottom portion B4, and a fourth line segment connecting the fourth bottom portion B4 and the fourth end portion E4 all have a linear shape. At least one of the first line segment, the second line segment, the third line segment, and the fourth line segment may have a curved shape. When each line segment has a curved shape, each line segment may have an arc shape such that the center of curvature of the line segment is located outside the inner spring 13A2. That is, each line segment may have an arc shape that is recessed toward the central axis 13AA. Alternatively, each line segment may have an arc shape such that the center of curvature of the line segment is located inside the inner spring 13A2. That is, each line segment may have an arc shape that bulges in a direction away from the central axis 13AA.

In the first direction D1, a distance DT2 between the central axis 13AA extending along the second direction D2 and the second top portion T2 is shorter than a distance DE3 between the central axis 13AA and the third end portion E3, and a distance DE4 between the central axis 13AA and the fourth end portion E4. In the first direction D1, the distance DT2 between the central axis 13AA and the second top portion T2 is longer than a distance DB3 between the central axis 13AA and the third bottom portion B3, and a distance DB4 between the central axis 13AA and the fourth bottom portion B4.

In other words, in the first direction D1, the amount of protrusion of the second edge portion 13E2 with respect to the central axis 13AA at the second top portion T2 is smaller than the amount of protrusion with respect to the central axis 13AA at the third end portion E3 and the fourth end portion E4. In addition, in the first direction D1, the amount of protrusion of the second edge portion 13E2 with respect to the central axis 13AA at the second top portion T2 is larger than the amount of protrusion with respect to the central axis 13AA at the third bottom portion B3 and the fourth bottom portion B4.

In addition to the first edge portion 13E1, the second edge portion 13E2 has the third bottom portion B3, the second top portion T2, and the fourth bottom portion B4. Therefore, it is possible to further enhance the uniformity of the spring width in the inner spring 13A2 compared to a case where only the first edge portion 13E1 includes two bottom portions and a first top portion interposed between the two bottom portions.

The distance DT2 may be, for example, 10 μm or more and 20 μm or less. The distance DE3 and the distance DE4 may be, for example, 16 μm or more and 25 μm or less. The distance DB3 and the distance DB2 may be, for example, 5 μm or more and 15 μm or less.

In the second direction D2, a distance between the first top portion T1 and the second top portion T2 may be shorter than a distance between the first top portion T1 and the third bottom portion B3, and a distance between the first top portion T1 and the fourth bottom portion B4. In this case, the inner spring 13A2 tends to have a local maximum value of the spring width between the first top portion T1 and the second top portion T2 in the second direction D2. This reduces the risk of the inner sprint 13A2 having a constricted shape at only one location in the thickness direction, which suppresses variations in the spring width in the thickness direction of the inner spring 13A2.

In the second direction D2, the distance between the first top portion T1 and the second top portion T2 may be, for example, 0 μm or more and 10 μm or less. In the second direction D2, the distance between the first top portion T1 and the third bottom portion B3 may be, for example, 15 μm or more and 30 μm or less. In the second direction D2, the distance between the first top portion T1 and the fourth bottom portion B4 may be, for example, 15 μm or more and 30 μm or less.

In the second direction D2, the distance between the first top portion T1 and the second top portion T2 may be shorter than a distance between the second top portion T2 and the first bottom portion B1, and a distance between the second top portion T2 and the second bottom portion B2. In this case, the inner spring 13A2 tends to have a local maximum value of the spring width between the first top portion T1 and the second top portion T2 in the second direction D2. This reduces the risk of the inner sprint 13A2 having a constricted shape at only one location in the thickness direction, which suppresses variations in the spring width in the thickness direction of the inner spring 13A2.

In the second direction D2, the distance between the first top portion T1 and the second top portion T2 may be, for example, 0 μm or more and 10μm or less. In the second direction D2, the distance between the second top portion T2 and the first bottom portion B1 may be, for example, 15 μm or more and 30μm or less. In the second direction D2, the distance between the second top portion T2 and the second bottom portion B2 may be, for example, 15 μm or more and 30 μm or less.

From the viewpoint of increasing the local maximum value of the width W13A2 of the inner spring 13A2 along the first direction D1 between the first end portion E1 and the second end portion E2, it is preferable that the amount of offset between the position of the first top portion T1 and the position of the second top portion T2 in the second direction D2 is small. Furthermore, from the viewpoint of increasing the local maximum value of the width W13A2 of the inner spring 13A2 along the first direction D1 between the first end portion E1 and the second end portion E2, it is more preferable that the position of the first top portion T1 and the position of the second top portion T2 are the same.

Moreover, from the viewpoint of reducing the number of bending points in the inner spring 13A2, it is preferable that the amount of offset between the position of the first bottom portion B1 and the position of the third bottom portion B3 in the second direction D2 is small, and it is also preferable that the position of the first bottom portion B1 and the position of the third bottom portion B3 are the same.

The width W13A2 of the inner spring 13A2 along the first direction D1 may have a local maximum value at the first top portion T1 or the second top portion T2. This prevents the inner spring 13A2 from having a constricted shape at only one location in the thickness direction, which suppresses variations in the spring width in the thickness direction of the inner spring 13A2.

The width W13A2 of the inner spring 13A2 has a maximum value on either the first surface 10S1 or the second surface 10S2. From the viewpoint of increasing the rigidity of the inner spring 13A2, the percentage of the local maximum value with respect to the overall maximum value in the width W13A2 of the inner spring 13A2 may be, for example, 45% or more, preferably 60% or more, and more preferably 75% or more.

In the spring assembly 10, in the second direction D2, the distance between the first top portion T1 and the second top portion T2 may be shorter than a distance between the second top portion T2 and the first bottom portion B1, and a distance between the second top portion T2 and the second bottom portion B2. Furthermore, in the spring assembly 10, the width of the inner spring 13A2 along the first direction D1 may have a local maximum value at the first top portion T1, the second top portion T2, or between the first top portion T1 and the second top portion T2 in the second direction D2.

In addition, in the second direction D2, the width of the inner spring 13A2 may have a first local minimum value between the first end portion E1 and the first top portion T1, and a second local minimum value between the second end portion E2 and the first top portion T1. In the spring assembly 10, the percentage of the first local minimum value with respect to the local maximum value and the percentage of the second local minimum value with respect to the local maximum value may be each 66% or more. Preferably 68.9% or more, 69.4% or more, and more preferably 72.0% or more, 75.6% or more. This allows the outer shape of the inner spring 13A2 to approach a rectangular shape, making it possible to increase the strength of the inner spring 13A2.

Furthermore, in the spring assembly 10, in the second direction D2, the percentage of the distance between the local maximum value and the first local minimum value with respect to the thickness of the inner spring 13A2, and the percentage of the distance between the local maximum value and the second local minimum value with respect to the thickness of the inner spring 13A2 may be each 24% or less. Preferably 23.3% or less, 22.0% or less, and more preferably 21.3% or less, 20.0% or less. This causes the position at which the width along the first direction D1 becomes narrow in the inner spring 13A2 to approach the first top portion T1, making it possible to enhance the resistance of the inner spring 13A2 to deformation.

Moreover, in the spring assembly 10, in the second direction D2, the percentage of the distance between the first local minimum value and the second local minimum value with respect to the thickness of the inner spring 13A2 may be 39% or more and 46% or less. Preferably 39.3% or more and 42.0% or less, 44.7% or more and 46.0% or less. As a result, biasing in the shape of the inner spring 13A2 is less likely to occur in the second direction D2, making it possible to further enhance the strength of the inner spring 13A2.

As described above, the thickness of the inner spring 13A2 may be, for example, 150 μm or more. The thicker the metal foil, the more the erosion of the metal foil progresses along the width direction of the spring 13A when the metal foil is subjected to wet etching, and the constriction of the inner spring 13A2 tends to become significant. In this respect, according to the spring assembly 10 of the present embodiment, even when a thick spring 13A with a thickness of 15 0μm or more is manufactured by wet etching a metal foil, an increase in the difference between the minimum value and the maximum value of the spring width in the thickness direction is suppressed.

In addition, as described above, the pitch P of the plurality of springs 13A may be, for example, 100 μm or more and 200 μm or less, and the maximum value of the width of each spring 13A along the first direction D1 may be one-half of the pitch or less. In this case, in the vicinity of the spring 13A, the etching amount of the metal foil becomes large enough to etch at least half of the metal foil in the first direction D1, and the constriction of the inner spring 13A2 tends to become significant. Therefore, the effect of the inner spring 13A2 having the first edge portion 13E1 can be significantly obtained.

### Method of Manufacturing Spring assembly

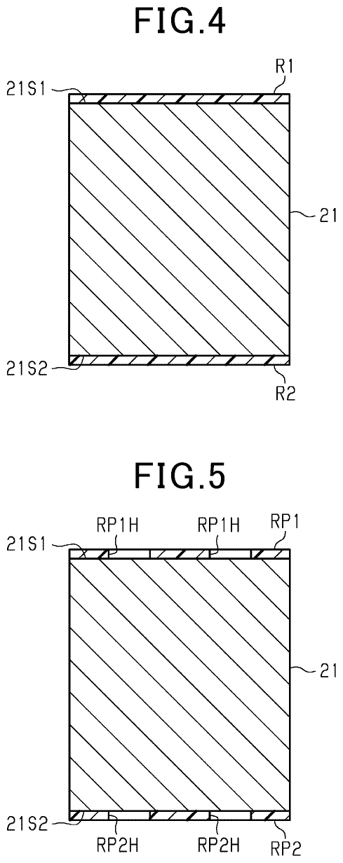

A method of manufacturing the spring assembly 10 will be described with reference to FIGS. 4 to 8.

As shown in FIG. 4, a metal foil 21 for the spring assembly 10 is prepared. The metal foil 21 includes a first surface 21S1 and a second surface 21S2, which is the surface opposite to the first surface 21S1. The metal foil 21, for example, may include at least one material selected from a group consisting of stainless alloy, beryllium copper, nickel-tin copper, phosphor bronze, Corson alloy, and titanium copper. The thickness of the metal foil 21 may be, for example, 150 μm or more.

Next, a first resist layer R1 is formed on the first surface 21S1 of the metal foil 21, and a second resist layer R2 is formed on the second surface 21S2. Each of the resist layers R1 and R2 may be formed from a negative-type resist, or may be formed from a positive-type resist. Each of the resist layers R1 and R2 may be formed by coating, or may be formed by laminating a dry film resist onto the metal foil 21.

As shown in FIG. 5, a resist pattern is formed by performing exposure and development on each of the resist layers R1 and R2. Specifically, a first resist pattern RP1 having a through-hole RP1H is formed from the first resist layer R1, and a second resist pattern RP2 having a through-hole RP2H is formed from the second resist layer R2.

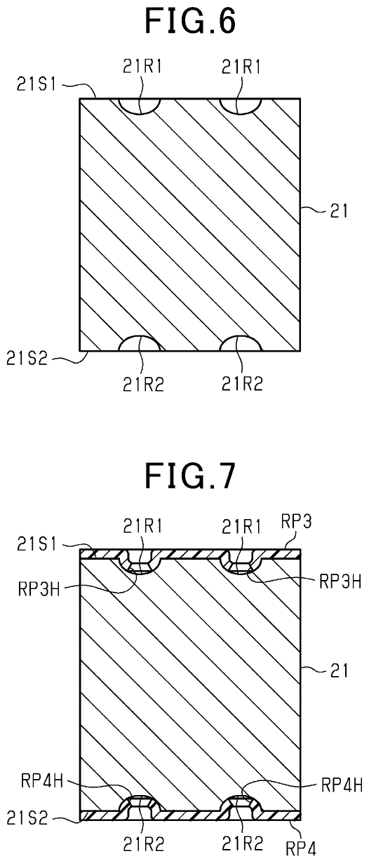

As shown in FIG. 6, using each of the resist patterns RP1 and RP2, wet etching is performed with respect to the metal foil 21 from both the first surface 21S1 and the second surface 21S2. This forms a first recess portion 21R1 that is recessed from the first surface 21S1 in the metal foil 21, and a second recess portion 21R2 that is recessed from the second surface 21S2. Then, the first resist pattern RP1 is released from the first surface 21S1, and the second resist pattern RP2 is released from the second surface 21S2.

As shown in FIG. 7, a third resist pattern RP3 is formed on the first surface 21S1 of the metal foil 21, and a fourth resist pattern RP4 is formed on the second surface 21S2. At this time, first, a resist layer is formed on the entire first surface 21S1 along the inner surface of the first recess portion 21R1, and a resist layer is formed on the entire second surface 21S2 along the inner surface of the second recess portion 21R2. Then, the third resist pattern RP3 and the fourth resist pattern RP4 are formed by performing exposure and development on with respect to each resist layer. The third resist pattern RP3 has a through-hole RP3H located at a bottom portion of the first recess portion 21R1. The third resist pattern RP3 covers the side surface of the first recess portion 21R1. The fourth resist pattern RP4 has a through-hole RP4H located at a bottom portion of the second recess portion 21R2. The fourth resist pattern RP4 covers the side surface of the second recess portion 21R2.

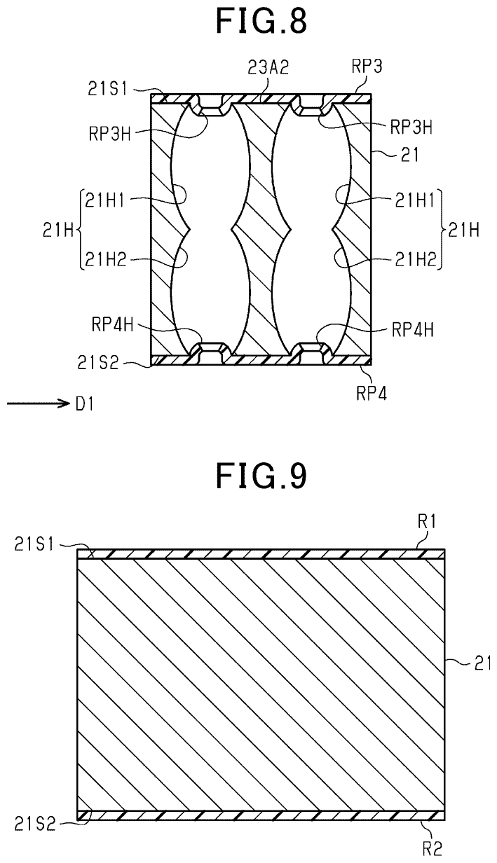

As shown in FIG. 8, using each of the resist patterns RP3 and RP4, the metal foil 21 is subjected to wet etching from both the first surface 21S1 and the second surface 21S2. As a result, a first hole portion 21H1 is formed by the progression of etching of the first recess portion 21R1, and a second hole portion 21H2 is formed by the progression of etching of the second recess portion 21R2. Then, a through-hole 21H that penetrates through the metal foil 21 is formed by the connection of the first hole portion 21H1 to the second hole portion 21H2.

Each of the hole portions 21H1 and 21H2 has a substantially elliptical shape in a cross-section orthogonal to the first surface 21S1. A section of the metal foil 21 interposed between two through-holes 21H is an etching pattern 23A2. The etching pattern 23A2 corresponds to the inner spring 13A2 included in the spring assembly 10.

According to the wet etching using the third resist pattern RP3 and the fourth resist pattern RP4, the resist patterns RP3 and RP4 have sections along the side surfaces of the recess portions 21R1 and 21R2. This facilitates anisotropic progression of the wet etching of the metal foil 21. That is, the resist patterns RP3 and RP4 make it easier for the etching solution to flow along the thickness direction, which facilitates the progression of etching of the metal foil 21 in the thickness direction.

According to such a method of manufacturing the spring assembly 10, it is possible to form the inner spring 13A2 such that the first edge portion 13E1 and the second edge portion 13E2 of the inner spring 13A2 have three bend portions in the thickness direction. This prevents the inner spring 13A2 from having a constricted shape near the center in the thickness direction, and an etching pattern 23A2 that is cut off at the center in the thickness direction by the etching of the metal foil 21 is not formed.

Furthermore, because the top portions T1 and T2 do not protrude in the first direction D1 beyond the end portions E1, E2, E3, and E4 that sandwich the top portions T1 and T2 in the thickness direction, contact between the inner spring 13A2 and an adjacent spring 13A is suppressed during use of the spring assembly 10.

The metal foil 21 for forming the spring assembly 10 may include a base material and a copper layer. The base material may include at least one material selected from a group consisting of stainless alloy, beryllium copper, nickel-tin copper, phosphor bronze, Corson alloy, and titanium copper. The base material includes a first surface, and a second surface opposite to the first surface. The copper layer may be located on at least one of the first surface and the second surface of the base material. That is, the copper layer may be located on both the first surface and the second surface, or may be located only on the first surface or only on the second surface. The method for forming the copper layer may be, for example, vacuum deposition, sputtering, wet plating, or the like.

In a case where the metal foil 21 includes a base material and one or more copper layers, the spring assembly 10 includes a base material and one or more copper layers. The base material of the spring assembly 10 is a portion of the base material of the metal foil 21, and the copper layer included in the spring assembly 10 is a portion of the copper layer included in the metal foil 21. The base material includes a first surface, and a second surface opposite to the first surface. The copper layer is located on at least one of the first surface and the second surface. That is, the copper layer may be located on both the first surface and the second surface of the base material, or may be located only on the first surface or only on the second surface.

### Test Examples

Test examples will be described with reference to FIGS. 4 to 22.

### Test Example 1

A titanium copper metal foil 21 with a thickness of 150 μm was prepared. Next, using a negative-type dry film resist (RY-5110 UT, manufactured by Resonac Corporation) with a thickness of 15 μm, a first resist layer R1 was formed on the first surface 21S1 of the metal foil 21, and a second resist layer R2 was formed on the second surface 21S2 of the metal foil 21.

A first resist pattern RP1 was formed by performing exposure and development on the first resist layer R1. Furthermore, a second resist pattern RP2 was formed by performing exposure and development on the second resist layer R2. At this time, in a cross-section orthogonal to the surface of each of the resist patterns RP1 and RP2 and along the direction in which the etching patterns corresponding to the springs were arranged side-by-side, the width of the through-holes RP1H and RP2H of the resist patterns RP1 and RP2 was set to 30 μm. Also, the through-holes RP1H and RP2H were formed at equal intervals in the direction in which the etching patterns were arranged side-by-side such that the pitch P of the springs became 130 μm.

Then, the metal foil 21 was etched using a ferric chloride solution. This formed a first recess portion 21R1 on the first surface 21S1 of the metal foil 21, and a second recess portion 21R2 on the second surface 21S2. Then, the first resist pattern RP1 was released from the first surface 21S1, and the second resist pattern RP2 was released from the second surface 21S2.

Next, a resist layer with a thickness of about 5 μm to 8 μm was formed on the first surface 21S1 and the second surface 21S2 of the metal foil 21 by electrodeposition. At this time, a positive-type photoresist for plating (HONNYRESIST AP-1000-D, manufactured by Honny Chemicals Co., Ltd.) was used. Then, by performing exposure and development on each resist layer, a third resist pattern RP3 was formed on the first surface 21S1, and a fourth resist pattern RP4 was formed on the second surface 21S2. At this time, through-holes RP3H and RP4H with a width of 38 μm were formed in each of the resist patterns RP3 and RP4. Also, the through-holes RP3H and RP4H were formed at equal intervals in the direction in which the etching patterns were arranged side-by-side such that the pitch P of the springs became 130 μm.

Then, the metal foil 21 was etched using a ferric chloride solution. This formed a through-hole 21H composed of a first hole portion 21H1 and a second hole portion 21H2 in the metal foil 21. As a result, a metal foil 21 including two etching patterns 23A2 was obtained.

### Test Example 2

In Test Example 1, the width of the through-hole RP1H in the first resist pattern RP1 and the through-hole RP2H in the second resist pattern RP2 was changed to 20 μm, and the spring pitch P was changed to 120 μm. The width of the through-hole RP3H of the third resist pattern RP3 and the through-hole RP4H of the fourth resist pattern RP4 was changed to 28 μm. Otherwise, the metal foil 21 of Test Example 2 was obtained by the same method as in Test Example 1.

### Test Example 3

Test Example 3 will be described with reference to FIGS. 9 to 11.

As shown in FIG. 9, in Test Example 3, a titanium copper metal foil 21 with a thickness of 150 μm was prepared. Then, a first resist layer R1 was formed on the first surface 21S1 of the metal foil 21, and a second resist layer R2 was formed on the second surface 21S2. The titanium copper metal foil 21, the first resist layer R1, and the second resist layer R2 in Test Example 3 were the same as the metal foil 21, the first resist layer R1, and the second resist layer R2 of Test Example 1.

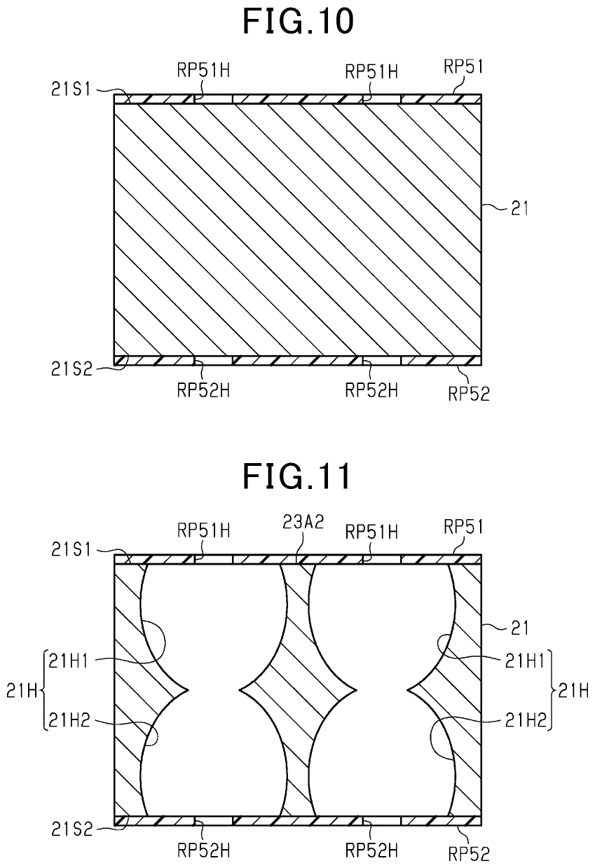

As shown in FIG. 10, a resist pattern was formed by performing exposure and development on each of the resist layers R1 and R2. Specifically, a first resist pattern RP51 having a through-hole RP51H was formed from the first resist layer R1, and a second resist pattern RP52 having a through-hole RP52H was formed from the second resist layer R2. At this time, the width of the through-holes RP51H and RP52H in each of the resist patterns RP51 and RP52 was set to 22 μm, and the through-holes RP51H and RP52H were formed at equal intervals in the direction in which the etching patterns were arranged side-by-side such that the spring pitch P became 130 μm.

As shown in FIG. 11, the metal foil 21 was etched using a ferric chloride solution. This formed a through-hole 21H composed of a first hole portion 21H1 opening on the first surface 21S1 and a second hole portion 21H2 opening on the second surface 21S2 in the metal foil 21. As a result, a metal foil 21 including the etching patterns 23A2 was obtained.

### Test Example 4

In Test Example 3, the width of the through-hole RP51H in the first resist pattern RP51 and the width of the through-hole RP51H in the second resist pattern RP52 was changed to 12 μm, and the spring pitch P was changed to 120 μm. Otherwise, the metal foil 21 of Test Example 4 was obtained by the same method as in Test Example 3.

### Test Example 5

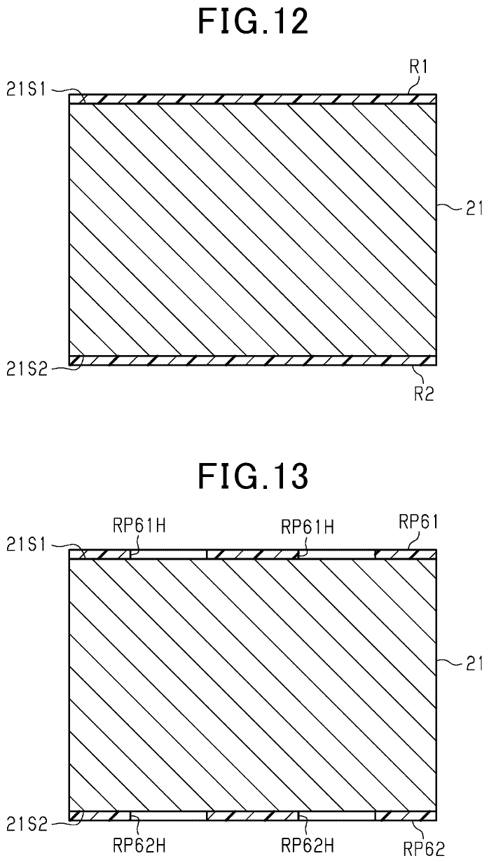

Test Example 5 will be described with reference to FIGS. 12 to 14.

As shown in FIG. 12, in Test Example 5, a titanium copper metal foil 21 with a thickness of 150 μm was prepared. Then, a first resist layer R1 was formed on the first surface 21S1 of the metal foil 21, and a second resist layer R2 was formed on the second surface 21S2. The titanium copper metal foil 21, the first resist layer R1, and the second resist layer R2 in Test Example 5 were the same as the metal foil 21, the first resist layer R1, and the second resist layer R2 of Test Example 1.

As shown in FIG. 13, a resist pattern was formed by performing exposure and development on each of the resist layers R1 and R2. Specifically, a first resist pattern RP61 having a through-hole RP61H was formed from the first resist layer R1, and a second resist pattern RP62 having a through-hole RP62H was formed from the second resist layer R2. At this time, the width of the through-holes RP61H and RP62H in each of the resist patterns RP61 and RP62 was set to 38μm, and the through-holes RP61H and RP62H were formed at equal intervals in the direction in which the etching patterns are arranged side-by-side such that the spring pitch P became 130 μm.

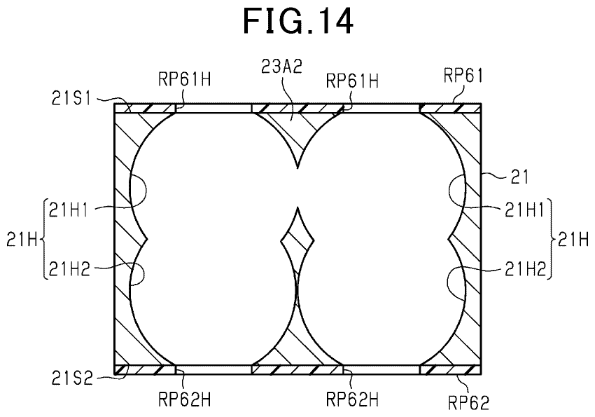

As shown in FIG. 14, the metal foil 21 was etched using a ferric chloride solution. This formed a through-hole 21H composed of a first hole portion 21H1 opening on the first surface 21S1 and a second hole portion 21H2 opening on the second surface 21S2 in the metal foil 21. As a result, a metal foil 21 including the etching patterns 23A2 was obtained.

### Test Example 6

In Test Example 5, the width of the through-hole RP61H in the first resist pattern RP61 and the width of the through-hole RP62H in the second resist pattern RP62 was set to 28 μm, and the spring pitch P was changed to 120 μm. Otherwise, the metal foil 21 of Test Example 6 was obtained by the same method as in Test Example 5.

### Evaluation Method

From the metal foil 21 of each Example and Test Example, a section including two etching patterns was cut out as a measurement sample. Then, an embedded sample was created by embedding the measurement sample in resin. As a result of cutting the embedded sample using a microtome, a cross-section along a plane orthogonal to the first surface 21S1, which is a cross-sectional structure of the etching pattern, was formed.

Using an optical microscope (VHX-7000, manufactured by Keyence Corporation), the cross-section of the embedded sample was observed, and for each etching pattern, the positions of each end portion, each bottom portion, and each top portion in an XY coordinate system were measured. At this time, the magnification of the objective lens was set to 200x. Furthermore, the position of each part of the etching pattern was measured such that the thickness direction of the etching pattern was the Y coordinate and the width direction of the etching pattern was the X coordinate.

### Evaluation Results

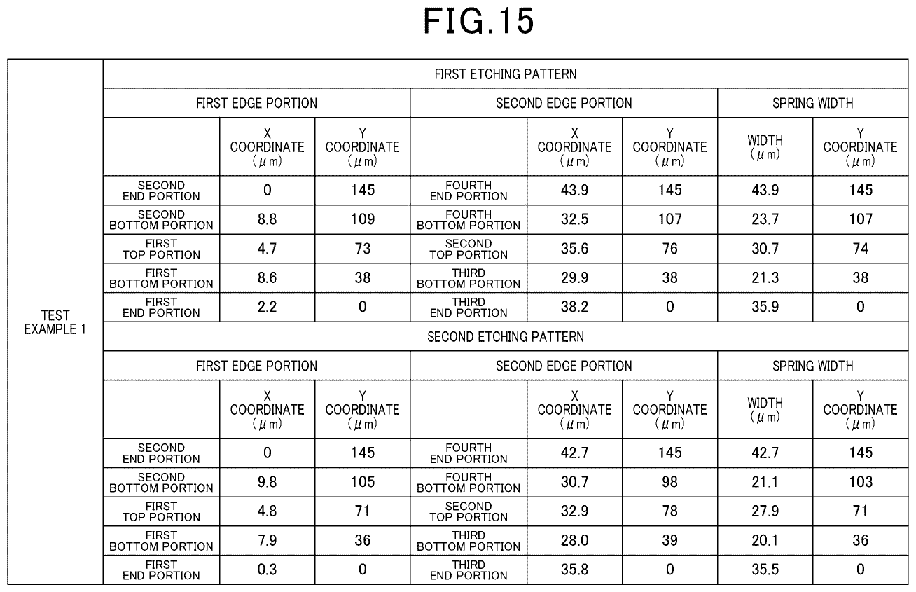

The measurement results for each test example were as shown in FIG. 15 to FIG. 18. Note that, in Test Examples 5 and 6, as shown in FIG. 14, it was observed that the etching pattern 23A2 formed in the metal foil 21 was cut off partway along the thickness direction. Therefore, measurements of the embedded samples of Test Examples 5 and 6 were not performed.

In the measurement results shown in FIG. 15 to FIG. 18, for the Y coordinate, after excluding 2% of the measurement data in both the direction from the first surface 21S1 to the second surface 21S2 and the direction from the second surface 21S2 to the first surface 21S1, the minimum position in the direction from the first surface 21S1 to the second surface 21S2 was set to 0. In addition, in the measurement results shown in FIG. 15 to FIG. 18, for the X coordinate, at the first edge portion of the first etching pattern, the position with the smallest numerical value of the X coordinate at the time of measurement was set to 0. Note that the first edge portion of the etching pattern corresponds to the first edge portion of the inner spring, and the second edge portion of the etching pattern corresponds to the second edge portion of the inner spring. In the second etching pattern, at the first edge portion, the position with the smallest numerical value of the X coordinate at the time of measurement was set to 0. In each of the Examples and Test Examples, an axis passing through the center of the etching pattern 23A2 on the second surface 21S2 and extending along the second direction is the central axis of the etching pattern 23A2.

As shown in FIG. 15, in Test Example 1, for the first edge portion of the first etching pattern, it was observed that the position of the second end portion was (0, 145), the position of the second bottom portion was (8.8, 109), the position of the first top portion was (4.7, 73), the position of the first bottom portion was (8.6, 38), and the position of the first end portion was (2.2, 0). Also, for the second edge portion, it was observed that the position of the fourth end portion was (43.9, 145), the position of the fourth bottom portion was (32.5, 107), the position of the second top portion was (35.6, 76), the position of the third bottom portion was (29.9, 38), and the position of the third end portion was (38.2, 0).

It was observed that the spring width was 43.9 μm at the position where the Y coordinate was 145 μm, 23.7μm at the position where the Y coordinate was 107 μm, 30.7 μm at the position where the Y coordinate was 74 μm, 21.3 μm at the position where the Y coordinate was 38 μm, and 35.9 μm at the position where the Y coordinate was 0 μm.

It was observed that the spring width had minimum values at the positions where the Y coordinate was 107 μm and the Y coordinate was 38 μm, and had a local maximum value at the position where the Y coordinate was 74 μm.

Furthermore, for the first edge portion of the second etching pattern, it was observed that the position of the second end portion was (0, 145), the position of the second bottom portion was (9.8, 105), the position of the first top portion was (4.8, 71), the position of the first bottom portion was (7.9, 36), and the position of the first end portion was (0.3, 0). Moreover, for the second edge portion, it was observed that the position of the fourth end portion was (42.7, 145), the position of the fourth bottom portion was (30.7, 98), the position of the second top portion was (32.9, 78), the position of the third bottom portion was (28.0, 39), and the position of the third end portion was (35.8, 0).

It was observed that the spring width was 42.7 μm at the position where the Y coordinate was 145 μm, 21.1 μm at the position where the Y coordinate was 103 μm, 27.9 μm at the position where the Y coordinate was 71 μm, 20.1 μm at the position where the Y coordinate was 36 μm, and 35.5 μm at the position where the Y coordinate was 0 μm.

It was observed that the spring width had minimum values at the positions where the Y coordinate was 103 μm and the Y coordinate was 36 μm, and had a local maximum value at the position where the Y coordinate was 71 μm.

In this way, in each etching pattern of Test Example 1, it was observed that, in the first direction D1, the amount of protrusion of the first top portion of the first edge portion with respect to the central axis of the etching pattern was smaller than the amount of protrusion of each end portion with respect to the central axis, and larger than the amount of protrusion of each bottom portion with respect to the central axis. Also, it was observed that, in the first direction D1, the amount of protrusion of the second top portion of the second edge portion with respect to the central axis of the etching pattern was smaller than the amount of protrusion of each end portion with respect to the central axis, and larger than the amount of protrusion of each bottom portion with respect to the central axis. That is, it was confirmed that the spring assembly 10 described above could be manufactured by the method of manufacturing a spring assembly of Test Example 1. Note that, as long as the spring assembly 10 described above can be manufactured, the method of manufacturing the spring assembly 10 is not limited to the method of manufacturing the spring assembly 10 of Test Example 1.

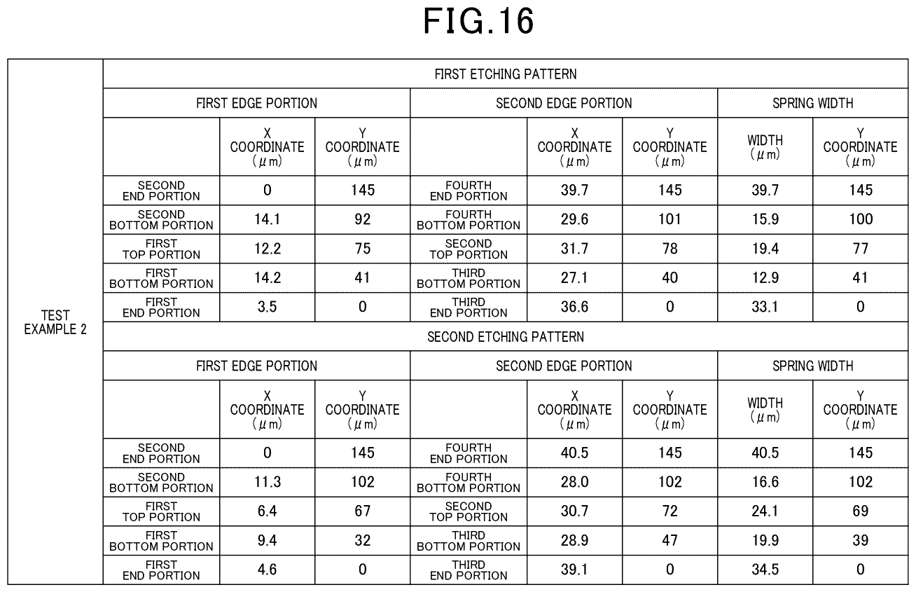

As shown in FIG. 16, in Test Example 2, for the first edge portion of the first etching pattern, it was observed that the position of the second end portion was (0, 145), the position of the second bottom portion was (14.1, 92), the position of the first top portion was (12.2, 75), the position of the first bottom portion was (14.2, 41), and the position of the first end portion was (3.5, 0). Also, for the second edge portion, it was observed that the position of the fourth end portion was (39.7, 145), the position of the fourth bottom portion was (29.6, 101), the position of the second top portion was (31.7, 78), the position of the third bottom portion was (27.1, 40), and the position of the third end portion was (36.6, 0).

It was observed that the spring width was 39.7 μm at the position where the Y coordinate was 145 μm, 15.9 μm at the position where the Y coordinate was 100 μm, 19.4 μm at the position where the Y coordinate was 77 μm, 12.9 μm at the position where the Y coordinate was 41 μm, and 33.1 μm at the position where the Y coordinate was 0 μm.

It was observed that the spring width had minimum values at the positions where the Y coordinate was 100 μm and the Y coordinate was 41 μm, and had a local maximum value at the position where the Y coordinate was 77 μm.

Furthermore, for the first edge portion of the second etching pattern, it was observed that the position of the second end portion was (0, 145), the position of the second bottom portion was (11.3, 102), the position of the first top portion was (6.4, 67), the position of the first bottom portion was (9.4, 32), and the position of the first end portion was (4.6, 0). Moreover, for the second edge portion, it was observed that the position of the fourth end portion was (40.5, 145), the position of the fourth bottom portion was (28.0, 102), the position of the second top portion was (30.7, 72), the position of the third bottom portion was (28.9, 47), and the position of the third end portion was (39.1, 0).

It was observed that the spring width was 40.5 μm at the position where the Y coordinate was 145 μm, 16.6 μm at the position where the Y coordinate was 102 μm, 24.1 μm at the position where the Y coordinate was 69 μm, 19.9 μm at the position where the Y coordinate was 39 μm, and 34.5 μm at the position where the Y coordinate was 0 μm.

It was observed that the spring width had minimum values at the positions where the Y coordinate was 102 μm and the Y coordinate was 39 μm, and had a local maximum value at the position where the Y coordinate was 69 μm.

In this way, in each etching pattern of Test Example 2, it was observed that, in the first direction D1, the amount of protrusion of the first top portion of the first edge portion with respect to the central axis of the etching pattern was smaller than the amount of protrusion of each end portion with respect to the central axis, and larger than the amount of protrusion of each bottom portion with respect to the central axis. Also, it was observed that, in the first direction D1, the amount of protrusion of the second top portion of the second edge portion with respect to the central axis of the etching pattern was smaller than the amount of protrusion of each end portion with respect to the central axis, and larger than the amount of protrusion of each bottom portion with respect to the central axis. That is, it was confirmed that the spring assembly 10 could be manufactured by the method of manufacturing a spring assembly of Test Example 2. Note that, as long as the spring assembly 10 described above can be manufactured, the method of manufacturing the spring assembly 10 is not limited to the method of manufacturing the spring assembly 10 of Test Example 2.

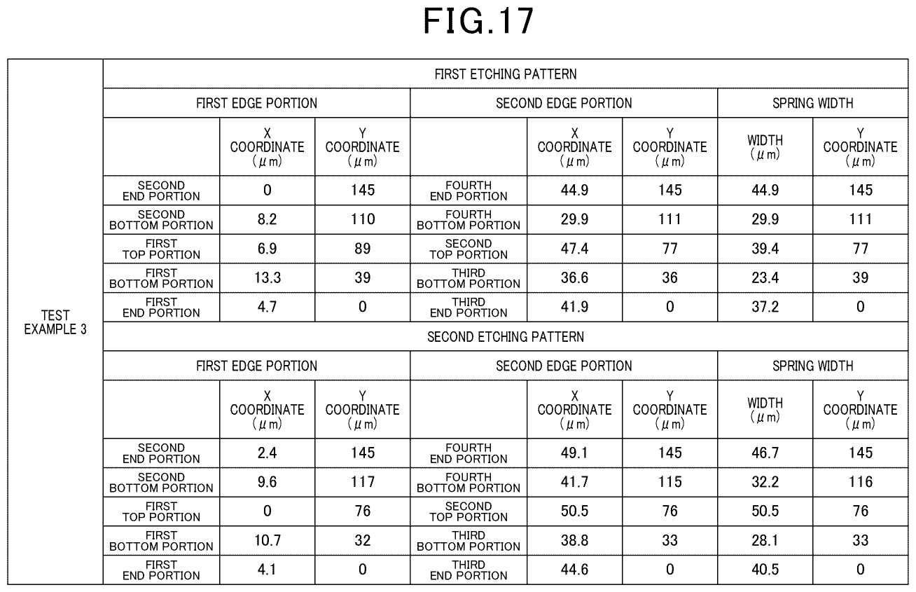

As shown in FIG. 17, in Test Example 3, for the first edge portion of the first etching pattern, it was observed that the position of the second end portion was (0, 145), the position of the second bottom portion was (8.2, 110), the position of the first top portion was (6.9, 89), the position of the first bottom portion was (13.3, 39), and the position of the first end portion was (4.7, 0). Furthermore, for the second edge portion, it was observed that the position of the fourth end portion was (44.9, 145), the position of the fourth bottom portion was (29.9, 111), the position of the second top portion was (47.4, 77), the position of the third bottom portion was (36.6, 36), and the position of the third end portion was (41.9, 0).

It was observed that the spring width was 44.9 μm at the position where the Y coordinate was 145 μm, 29.9 μm at the position where the Y coordinate was 111 μm, 39.4 μm at the position where the Y coordinate was 77 μm, 23.4 μm at the position where the Y coordinate was 39 μm, and 37.2 μm at the position where the Y coordinate was 0 μm.

It was observed that the spring width had minimum values at the positions where the Y coordinate was 111 μm and the Y coordinate was 39 μm, and had a local maximum value at the position where the Y coordinate was 77 μm.

In addition, for the first edge portion of the second etching pattern, it was observed that the position of the second end portion was (2.4, 145), the position of the second bottom portion was (9.6, 117), the position of the first top portion was (0, 76), the position of the first bottom portion was (10.7, 32), and the position of the first end portion was (4.1, 0). Also, for the second edge portion, it was observed that the position of the fourth end portion was (49.1, 145), the position of the fourth bottom portion was (41.7, 115), the position of the second top portion was (50.5, 76), the position of the third bottom portion was (38.8, 33), and the position of the third end portion was (44.6, 0).

It was observed that the spring width was 46.7 μm at the position where the Y coordinate was 145 μm, 32.2 μm at the position where the Y coordinate was 116 μm, 50.5 μm at the position where the Y coordinate was 76 μm, 28.1 μm at the position where the Y coordinate was 33 μm, and 40.5 μm at the position where the Y coordinate was 0 μm.

It was observed that the spring width had minimum values at the positions where the Y coordinate was 116 μm and the Y coordinate was 33 μm, and had a local maximum value at the position where the Y coordinate was 76 μm.

In this way, in the first etching pattern of Test Example 3, it was observed that, in the first direction D1, while the amount of protrusion of the first top portion of the first edge portion with respect to the central axis of the etching pattern was smaller than the amount of protrusion of each end portion with respect to the central axis, the amount of protrusion of the second top portion of the second edge portion with respect to the central axis of the etching pattern was larger than the amount of protrusion of each end portion with respect to the central axis. Furthermore, in the second etching pattern, it was observed that the amount of protrusion of the first top portion of the first edge portion with respect to the central axis of the etching pattern was larger than the amount of protrusion of each end portion with respect to the central axis. Moreover, in the second etching pattern, it was observed that, in the first direction D1, the amount of protrusion of the second top portion of the second edge portion with respect to the central axis of the etching pattern was larger than the amount of protrusion of each end portion with respect to the central axis. Therefore, in the spring assembly of Test Example 3, the probability of the protruding top portions coming into contact with each other during operation, and causing damage to the spring assembly, is increased.

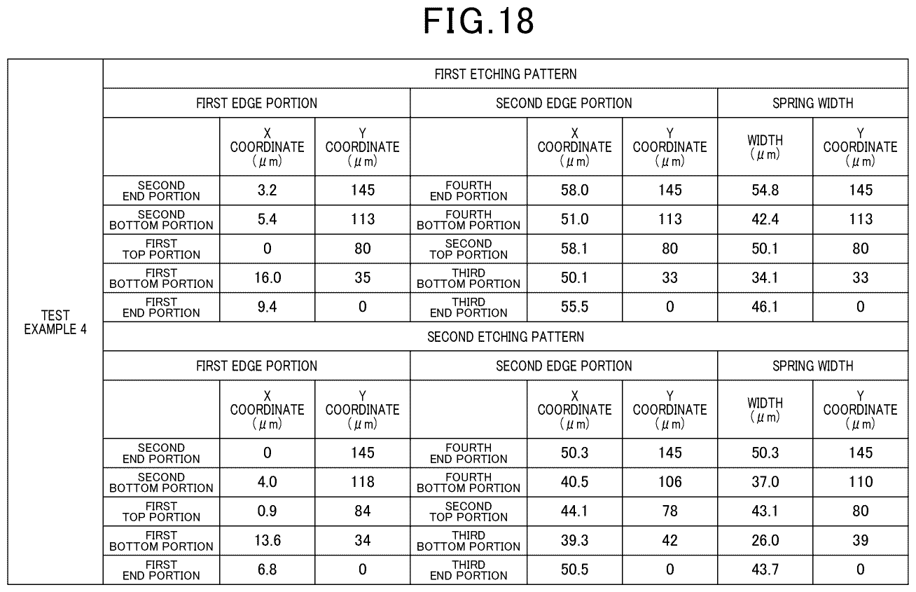

As shown in FIG. 18, in Test Example 4, for the first edge portion of the first etching pattern, it was observed that the position of the second end portion was (3.2, 145), the position of the second bottom portion was (5.4, 113), the position of the first top portion was (0, 80), the position of the first bottom portion was (16.0, 35), and the position of the first end portion was (9.4, 0). Also, for the second edge portion, it was observed that the position of the fourth end portion was (58.0, 145), the position of the fourth bottom portion was (51.0, 113), the position of the second top portion was (58.1, 80), the position of the third bottom portion was (50.1, 33), and the position of the third end portion was (55.5, 0).

It was observed that the spring width was 54.8 μm at the position where the Y coordinate was 145 μm, 42.4 μm at the position where the Y coordinate was 113 μm, 50.1 μm at the position where the Y coordinate was 80 μm, 34.1 μm at the position where the Y coordinate was 33 μm, and 46.1 μm at the position where the Y coordinate was 0 μm.

It was observed that the spring width had minimum values at the positions where the Y coordinate was 113 μm and the Y coordinate was 33 μm, and had a local maximum value at the position where the Y coordinate was 80 μm.

Also, for the first edge portion of the second etching pattern, it was observed that the position of the second end portion was (0, 145), the position of the second bottom portion was (4.0, 118), the position of the first top portion was (0.9, 84), the position of the first bottom portion was (13.6, 34), and the position of the first end portion was (6.8, 0). In addition, for the second edge portion, it was observed that the position of the fourth end portion was (50.3, 145), the position of the fourth bottom portion was (40.5, 106), the position of the second top portion was (44.1, 78), the position of the third bottom portion was (39.3, 42), and the position of the third end portion was (50.5, 0).

It was observed that the spring width was 50.3 μm at the position where the Y coordinate was 145 μm, 37.0 μm at the position where the Y coordinate was 110 μm, 43.1 μm at the position where the Y coordinate was 80 μm, 26.0 μm at the position where the Y coordinate was 39 μm, and 43.7 μm at the position where the Y coordinate was 0 μm.

It was observed that the spring width had minimum values at the positions where the Y coordinate was 110 μm and the Y coordinate was 39 μm, and had a local maximum value at the position where the Y coordinate was 80 μm.

In this way, in the first etching pattern of Test Example 4, it was observed that, in the first direction D1, the amount of protrusion of the first top portion of the first edge portion with respect to the central axis of the etching pattern was larger than the amount of protrusion of each end portion with respect to the central axis. Also, it was observed that the amount of protrusion of the second top portion of the second edge portion with respect to the central axis of the etching pattern was larger than the amount of protrusion of each end portion with respect to the central axis. In addition, in the second etching pattern, it was observed that, in the first direction D1, the amount of protrusion of the first top portion of the first edge portion with respect to the central axis of the etching pattern was larger than the amount of protrusion of the first end portion with respect to the central axis. Therefore, in the spring assembly of Test Example 4, the probability of the protruding top portions coming into contact with each other during operation, and causing damage to the spring assembly, is increased.

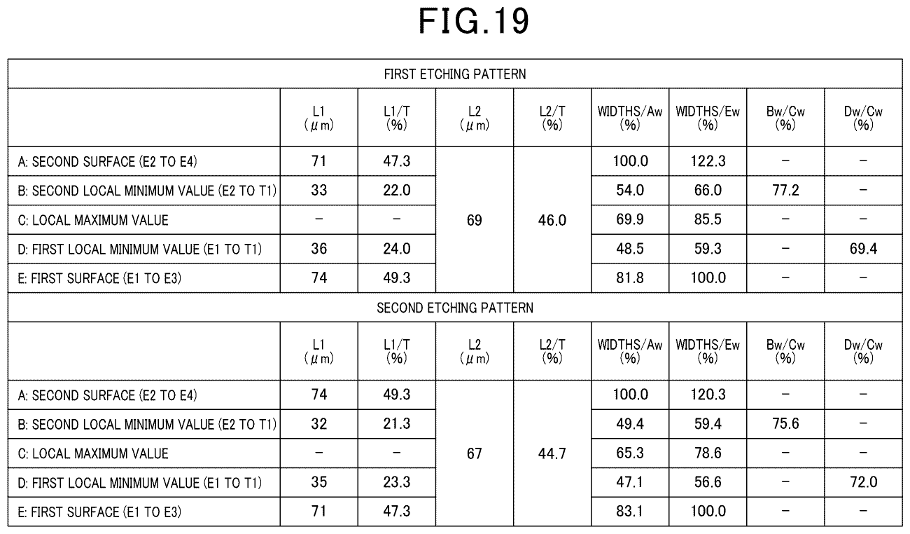

The results of the analysis of the etching patterns of each test example will be described with reference to FIGS. 19 to 22. Note that, in the following, in terms of the width of the etching pattern, the minimum value between the first end portion E1 and the first top portion T1 will be referred to as the first local minimum value, and the minimum value between the second end portion E2 and the first top portion T1 will be referred to as the second local minimum value.

Furthermore, in FIGS. 19 to 22, L1 is a first distance, T is the thickness of the etching pattern, and L2 is a second distance. Also, in FIGS. 19 to 22, Aw is the width of the etching pattern on the second surface 21S2, Bw is the second local minimum value, Cw is the local maximum value, Dw is the first local minimum value, and Ew is the width of the etching pattern on the first surface 21S1.

As shown in FIG. 19, in the first etching pattern of Test Example 1, it was observed that the first distance, which is the distance between the local maximum value in the Y coordinate and each position, was 71 μm at the second surface 21S2, 33 μm at the second local minimum value, 36 μm at the first local minimum value, and 74 μm at the first surface. Furthermore, it was observed that the percentage of each first distance with respect to the thickness of the etching pattern was 47.3% at the second surface 21S2, 22.0% at the second local minimum value, 24.0% at the first local minimum value, and 49.3% at the first surface 21S1. Moreover, it was observed that the second distance, which is the distance between the first local minimum value and the second local minimum value in the Y coordinate, was 69 μm. Also, it was observed that the percentage of the second distance with respect to the thickness of the etching pattern was 46.0%.

In the first etching pattern, it was observed that the percentage of the width at each position with respect to the width at the second surface 21S2 was 100.0% at the second surface 21S2, 54.0% at the second local minimum value, 69.9% at the local maximum value, 48.5% at the first local minimum value, and 81.8% at the first surface 21S1. It was observed that the percentage of the width at each position with respect to the width at the first surface 21S1 was 122.3% at the second surface 21S2, 66.0% at the second local minimum value, 85.5% at the local maximum value, 59.3% at the first local minimum value, and 100.0% at the first surface 21S1. It was observed that the percentage of the second local minimum value with respect to the local maximum value was 77.2%. It was observed that the percentage of the first local minimum value with respect to the local maximum value was 69.4%.

In the second etching pattern of Test Example 1, it was observed that the first distance was 74 μm at the second surface 21S2, 32 μm at the second local minimum value, 35 μm at the first local minimum value, and 71 μm at the first surface 21S1. Also, it was observed that the percentage of each first distance with respect to the thickness of the etching pattern was 49.3% at the second surface 21S2, 21.3% at the second local minimum value, 23.3% at the first local minimum value, and 47.3% at the first surface 21S1. In addition, it was observed that the second distance was 67 μm. Moreover, it was observed that the percentage of the second distance with respect to the thickness of the etching pattern was 44.7%.

In the second etching pattern, it was observed that the percentage of the width at each position with respect to the width at the second surface 21S2 was 100.0% at the second surface 21S2, 49.4% at the second local minimum value, 65.3% at the local maximum value, 47.1% at the first local minimum value, and 83.1% at the first surface 21S1. It was observed that the percentage of the width at each position with respect to the width at the first surface 21S1 was 120.3% at the second surface 21S2, 59.4% at the second local minimum value, 78.6% at the local maximum value, 56.6% at the first local minimum value, and 100.0% at the first surface 21S1. It was observed that the width at the second local minimum value with respect to the local maximum value was 75.6%. It was observed that the width at the first local minimum value with respect to the local maximum value was 72.0%.

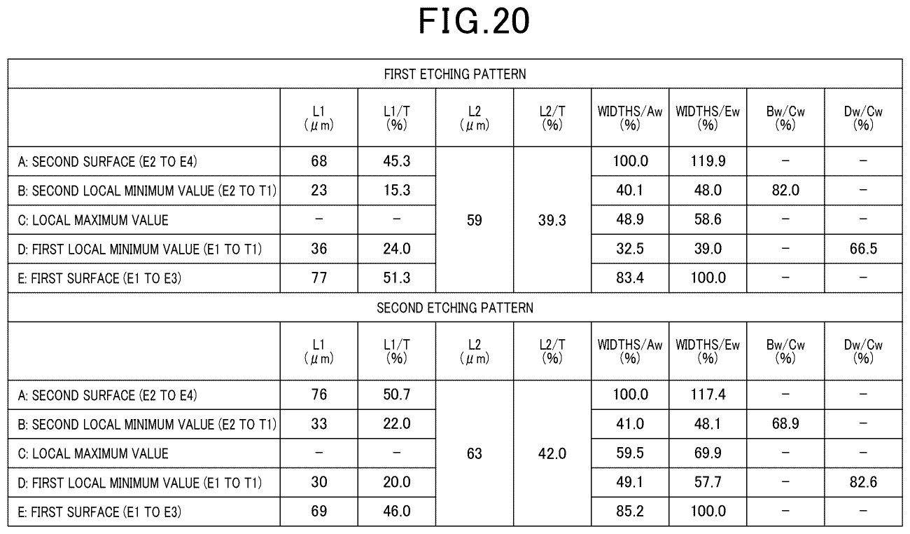

As shown in FIG. 20, in the first etching pattern of Test Example 2, it was observed that the first distance was 68 μm at the second surface 21S2, 23 μm at the second local minimum value, 36 μm at the first local minimum value, and 77 μm at the first surface 21S1. Furthermore, it was observed that the percentage of each first distance with respect to the thickness of the etching pattern was 45.3% at the second surface 21S2, 15.3% at the second local minimum value, 24.0% at the first local minimum value, and 51.3% at the first surface 21S1. In addition, it was observed that the second distance was 59 μm. Moreover, it was observed that the percentage of the second distance with respect to the thickness of the etching pattern was 39.3%.

In the first etching pattern, it was observed that the percentage of the width at each position with respect to the width at the second surface 21S2 was 100.0% at the second surface 21S2, 40.1% at the second local minimum value, 48.9% at the local maximum value, 32.5% at the first local minimum value, and 83.4% at the first surface 21S1. It was observed that the percentage of the width at each position with respect to the width at the first surface 21S1 was 119.9% at the second surface 21S2, 48.0% at the second local minimum value, 58.6% at the local maximum value, 39.0% at the first local minimum value, and 100.0% at the first surface 21S1. It was observed that the percentage of the width at the second local minimum value with respect to the local maximum value was 82.0%. It was observed that the percentage of the width at the first local minimum value with respect to the local maximum value was 66.5%.

In the second etching pattern of Test Example 2, it was observed that the first distance was 76 μm at the second surface 21S2, 33 μm at the second local minimum value, 30 μm at the first local minimum value, and 69 μm at the first surface 21S1. Furthermore, it was observed that the percentage of each first distance with respect to the thickness of the etching pattern was 50.7% at the second surface 21S2, 22.0% at the second local minimum value, 20.0% at the first local minimum value, and 46.0% at the first surface. In addition, it was observed that the second distance was 63 μm. Moreover, it was observed that the percentage of the second distance with respect to the thickness of the etching pattern was 42.0%.

In the second etching pattern, it was observed that the percentage of the width at each position with respect to the width at the second surface 21S2 was 100.0% at the second surface 21S2, 41.0% at the second local minimum value, 59.5% at the local maximum value, 49.1% at the first local minimum value, and 85.2% at the first surface 21S1. It was observed that the percentage of the width at each position with respect to the width at the first surface 21S1 was 117.4% at the second surface 21S2, 48.1% at the second local minimum value, 69.9% at the local maximum value, 57.7% at the first local minimum value, and 100.0% at the first surface 21S1. It was observed that the percentage of the width at the second local minimum value with respect to the local maximum value was 68.9%. It was observed that the percentage of the width at the first local minimum value with respect to the local maximum value was 82.6%.

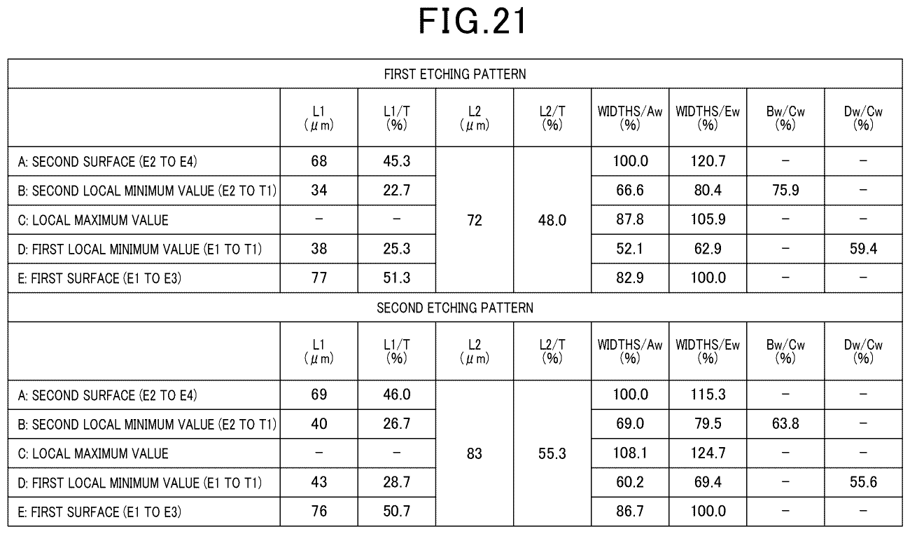

As shown in FIG. 21, in the first etching pattern of Test Example 3 it was observed that the first distance was 68 μm at the second surface 21S2, 34 μm at the second local minimum value, 38 μm at the first local minimum value, and 77 μm at the first surface 21S1. Furthermore, it was observed that the percentage of each first distance with respect to the thickness of the etching pattern was 45.3% at the second surface 21S2, 22.7% at the second local minimum value, 25.3% at the first local minimum value, and 51.3% at the first surface 21S1. In addition, it was observed that the second distance was 72 μm. Moreover, it was observed that the percentage of the second distance with respect to the thickness of the etching pattern was 48.0%.

In the first etching pattern, it was observed that the percentage of the width at each position with respect to the width at the second surface 21S2 was 100.0% at the second surface 21S2, 66.6% at the second local minimum value, 87.8% at the local maximum value, 52.1% at the first local minimum value, and 82.9% at the first surface 21S1. It was observed that the percentage of the width at each position with respect to the width at the first surface 21S1 was 120.7% at the second surface 21S2, 80.4% at the second local minimum value, 105.9% at the local maximum value, 62.9% at the first local minimum value, and 100.0% at the first surface 21S1. It was observed that the percentage of the width at the second local minimum value with respect to the local maximum value was 75.9%. It was observed that the percentage of the width at the first local minimum value with respect to the local maximum value was 59.4%.

In the second etching pattern of Test Example 3, it was observed that the first distance was 69 μm at the second surface 21S2, 40 μm at the second local minimum value, 43 μm at the first local minimum value, and 76 μm at the first surface 21S1. It was observed that the percentage of the first distance with respect to the thickness of the etching pattern was 46.0% at the second surface 21S2, 26.7% at the second local minimum value, 28.7% at the first local minimum value, and 50.7% at the first surface 21S1. In addition, it was observed that the second distance was 83 μm. Moreover, it was observed that the percentage of the second distance with respect to the thickness of the etching pattern was 55.3%.

In the second etching pattern, it was observed that the percentage of the width at each position with respect to the width at the second surface 21S2 was 100.0% at the second surface 21S2, 69.0% at the second local minimum value, 108.1% at the local maximum value, 60.2% at the first local minimum value, and 86.7% at the first surface 21S1. It was observed that the percentage of the width at each position with respect to the width at the first surface 21S1 was 115.3% at the second surface 21S2, 79.5% at the second local minimum value, 124.7% at the local maximum value, 69.4% at the first local minimum value, and 100.0% at the first surface 21S1. It was observed that the percentage of the width at the second local minimum value with respect to the local maximum value was 63.8%. It was observed that the percentage of the width at the first local minimum value with respect to the local maximum value was 55.6%.

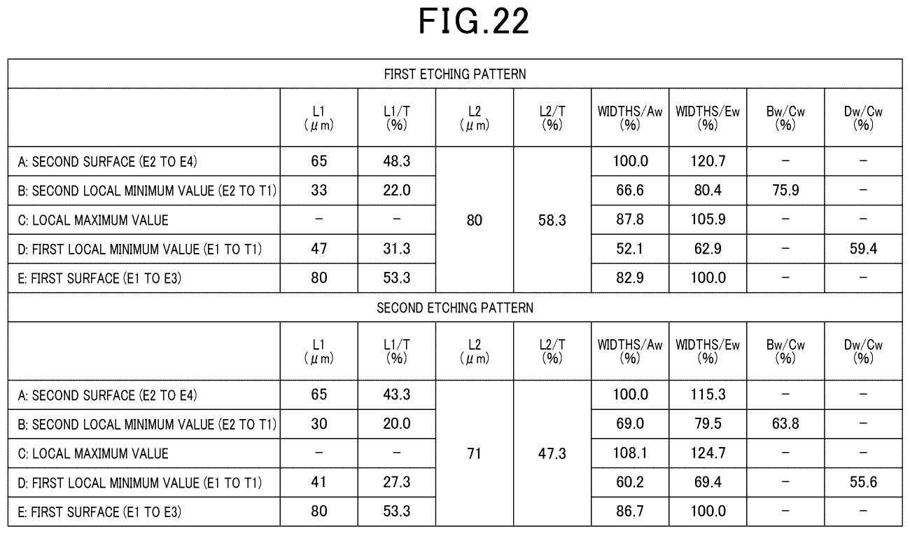

As shown in FIG. 22, in the first etching pattern of Test Example 4, it was observed that the first distance was 65 μm at the second surface 21S2, 33 μm at the second local minimum value, 47 μm at the first local minimum value, and 80 μm at the first surface 21S1. Also, it was observed that the percentage of the first distance with respect to the thickness of the etching pattern was 48.3% at the second surface 21S2, 22.0% at the second local minimum value, 31.3% at the first local minimum value, and 53.3% at the first surface 21S1. In addition, it was observed that the second distance was 80 μm. Moreover, it was observed that the percentage of the second distance with respect to the thickness of the etching pattern was 58.3%.

In the first etching pattern, it was observed that the percentage of the width at each position with respect to the width at the second surface 21S2 was 100.0% at the second surface 21S2, 66.6% at the second local minimum value, 87.8% at the local maximum value, 52.1% at the first local minimum value, and 82.9% at the first surface 21S1. It was observed that the percentage of the width at each position with respect to the width at the first surface 21S1 was 120.7% at the second surface 21S2, 80.4% at the second local minimum value, 105.9% at the local maximum value, 62.9% at the first local minimum value, and 100.0% at the first surface 21S1. It was observed that the percentage of the width at the second local minimum value with respect to the local maximum value was 75.9%. It was observed that the percentage of the width at the first local minimum value with respect to the local maximum value was 59.4%.

In the second etching pattern of Test Example 4, it was observed that the first distance was 65 μm at the second surface 21S2, 30 μm at the second local minimum value, 41 μm at the first local minimum value, and 80 μm at the first surface 21S1. Also, it was observed that the percentage of the first distance with respect to the thickness of the etching pattern was 43.3% at the second surface 21S2, 20.0% at the second local minimum value, 27.3% at the first local minimum value, and 53.3% at the first surface 21S1. In addition, it was observed that the second distance was 71 μm. Moreover, it was observed that the percentage of the second distance with respect to the thickness of the etching pattern was 47.3%.

In the second etching pattern, it was observed that the percentage of the width at each position with respect to the width at the second surface 21S2 was 100.0% at the second surface 21S2, 69.0% at the second local minimum value, 108.1% at the local maximum value, 60.2% at the first local minimum value, and 86.7% at the first surface 21S1. The ratio of the width at each position with respect to the width at the first surface 21S1 was observed to be 115.3% at the second surface, 79.5% at the second local minimum value, 124.7% at the local maximum value, 69.4% at the first local minimum value, and 100.0% at the first surface 21S1. It was observed that the percentage of the width at the second local minimum value with respect to the local maximum value was 63.8%. It was observed that the percentage of the width at the first local minimum value with respect to the local maximum value was 55.6%.

That is, in the etching patterns of Test Examples 1 and 2, it was observed that both the percentage of the first local minimum value with respect to the local maximum value and the percentage of the second local minimum value with respect to the local maximum value were 66% or more. In contrast, it was observed that Test Examples 3 and 4 include etching patterns in which at least one of the percentage of the first local minimum value with respect to the local maximum value and the percentage of the second local minimum value with respect to the local maximum value was less than 66%.

Furthermore, in the etching patterns of Test Examples 1 and 2, it was observed that both the percentage of the first distance at the first local minimum value with respect to the thickness of the etching pattern and the percentage of the first distance at the second local minimum value with respect to the thickness of the etching pattern were 24% or less. In contrast, it was observed that Test Examples 3 and 4 include etching patterns in which at least one of the percentage of the first distance at the first local minimum value with respect to the thickness of the etching pattern and the percentage of the first distance at the second local minimum value with respect to the thickness of the etching pattern exceeded 24%.

Moreover, in the etching patterns of Test Examples 1 and 2, it was observed that the percentage of the second distance with respect to the etching pattern was within the range of 39% or more and 46% or less. In contrast, in the etching patterns of Test Examples 3 and 4, it was observed that the percentage of the second distance with respect to the etching pattern exceeded 46%.

As described above, according to an embodiment of the spring assembly, the following effects can be obtained.
(1) Because the first edge portion 13E1 of the inner spring 13A2 has the first bottom portion B1, the first top portion T1, and the second bottom portion B2, it is possible to reduce the amount of constriction at each of the bottom portions B1 and B2 compared to a case where the inner spring 13A2 becomes constricted at a single location in the thickness direction. This makes it possible to enhance the uniformity of the spring width in the thickness direction of the inner spring 13A2.
(2) In addition to the first edge portion 13E1, the second edge portion 13E2 may have the third bottom portion B3, the second top portion T2, and the fourth bottom portion B4. In this case, it is possible to further enhance the uniformity of the spring width in the inner spring 13A2 compared to a case where only the first edge portion 13E1 includes two bottom portions and a top portion interposed between the two bottom portions.
(3) The inner spring 13A2 tends to have a local maximum value of the spring width between the first top portion T1 and the second top portion T2 in the second direction D2. This reduces the risk of the inner sprint 13A2 having a constricted shape at only one location in the thickness direction, which suppresses variations in the spring width in the thickness direction of the inner spring 13A2.
(4) The width of the inner spring 13A2 may have a local maximum value at the first top portion T1 or the second top portion T2. In this case, because the inner spring 13A2 does not have a constricted shape at only one location in the thickness direction, variations in the spring width in the thickness direction of the inner spring 13A2 can be suppressed.
(5) Even when the thick spring 13A with a thickness of 150 μm or more is manufactured by wet etching a metal foil 21, an increase in the difference between the minimum value and the maximum value of the spring width in the thickness direction is suppressed.
(6) In the vicinity of the spring 13A, because the etching amount of the metal foil 21 becomes large enough to etch at least half of the metal foil 21 in the first direction D1, the constriction of the inner spring 13A2 tends to become significant. Therefore, the effect of the inner spring 13A2 having the first edge portion 13E1 can be significantly obtained.

The embodiment described above may be modified and implemented as follows.

### First Edge Portion

The distance DT1 between the central axis 13AA and the first top portion T1 may be longer than either the distance DE1 between the central axis 13AA and the first end portion E1, or the distance DE2 between the central axis 13AA and the second end portion E2. Even in this case, the effect corresponding to (1) above can be obtained because the first edge portion 13E1 has the first bottom portion B1, the first top portion T1, and the second bottom portion B2.

### Second Edge Portion

The distance DT2 between the central axis 13AA and the second top portion T2 may be longer than either the distance between the central axis 13AA and the third end portion E3, or the distance between the central axis 13AA and the fourth end portion E4. Even in this case, the effect corresponding to (2) above can be obtained because the second edge portion 13E2 has the third bottom portion B3, the second top portion T2, and the fourth bottom portion B4.

### Inner Spring

The first edge portion 13E1 may have the first bottom portion B1, the first top portion T1, and the second bottom portion B2, while the second edge portion 13E2 does not have the third bottom portion B3, the second top portion T2, and the fourth bottom portion B4. Even in this case, the effect corresponding to (1) above can be obtained.
The second edge portion 13E2 may have the third bottom portion B3, the second top portion T2, and the fourth bottom portion B4, while the first edge portion 13E1 does not have the first bottom portion B1, the first top portion T1, and the second bottom portion B2. Even in this case, the effect corresponding to (1) above can be obtained.

### REFERENCE SIGNS LIST

10 ... Spring assembly
11 ... Outer frame portion
12 ... Inner frame portion
13 ... Spring portion
13A1 ... Outer spring
13A2 ... Inner spring
13E1 ... First edge portion
13E2 ... Second edge portion
B1 ... First bottom portion
B2 ... Second bottom portion
B3 ... Third bottom portion
B4 ... Fourth bottom portion
E1 ... First end portion
E2 ... Second end portion
E3 ... Third end portion
E4 ... Fourth end portion
T1 ... First top portion
T2 ... Second top portion

1. A spring assembly, comprising:
a first surface;
a second surface opposite to the first surface; and
a plurality of springs arranged side-by-side along a first direction in a cross-section orthogonal to the first surface, the plurality of springs including a pair of outer springs, and an inner spring interposed between the outer springs in the first direction; wherein
a direction orthogonal to the first direction is a second direction,
the inner spring includes a first edge portion and a second edge portion that face each other in the first direction,
the first edge portion includes a first end portion located on the first surface, a second end portion located on the second surface, and, in the second direction, a first bottom portion, a first top portion, and a second bottom portion located between the first end portion and the second end portion,
in the second direction, the first top portion is located between the first bottom portion and the second bottom portion,
in the first direction, a distance between a central axis of the inner spring extending along the second direction and the first top portion is shorter than at least one of a distance between the central axis and the first end portion, and a distance between the central axis and the second end portion, and
in the first direction, the distance between the central axis and the first top portion is longer than a distance between the central axis and the first bottom portion and a distance between the central axis and the second bottom portion.

2. The spring assembly according to claim 1, wherein
the second edge portion includes a third end portion located on the first surface, a fourth end portion located on the second surface, and, in the second direction, a third bottom portion, a second top portion, and a fourth bottom portion located between the third end portion and the fourth end portion,
in the second direction, the second top portion is located between the third bottom portion and the fourth bottom portion,
in the first direction, a distance between the central axis extending along the second direction and the second top portion is shorter than at least one of a distance between the central axis and the third end portion, and a distance between the central axis and the fourth end portion, and
in the first direction, the distance between the central axis and the second top portion is longer than a distance between the central axis and the third bottom portion and a distance between the central axis and the fourth bottom portion.

3. The spring assembly according to claim 2, wherein
in the second direction, a distance between the first top portion and the second top portion is shorter than a distance between the first top portion and the third bottom portion and a distance between the first top portion and the fourth bottom portion.

4. The spring assembly according to claim 2, wherein
in the second direction, the distance between the first top portion and the second top portion is shorter than a distance between the second top portion and the first bottom portion and a distance between the second top portion and the second bottom portion.

5. The spring assembly according to claim 2, wherein
a width of the inner spring along the first direction has a local maximum value at the first top portion, the second top portion, or between the first top portion and the second top portion in the second direction.

6. The spring assembly according to claim 5, wherein
in the second direction, the width of the inner spring has a first local minimum value between the first end portion and the first top portion, and has a second local minimum value between the second end portion and the first top portion, and
a percentage of the first local minimum value with respect to the local maximum value and a percentage of the second local minimum value with respect to the local maximum value are each 66% or more.

7. The spring assembly according to claim 5, wherein
in the second direction, the width of the inner spring has a first local minimum value between the first end portion and the first top portion, and has a second local minimum value between the second end portion and the first top portion, and
in the second direction, a percentage of a distance between the local maximum value and the first local minimum value with respect to the thickness of the inner spring and a percentage of a distance between the local maximum value and the second local minimum value with respect to the thickness of the inner spring are each 24% or less.

8. The spring assembly according to claim 5, wherein
in the second direction, the width of the inner spring has a first local minimum value between the first end portion and the first top portion, and has a second local minimum value between the second end portion and the second top portion, and
in the second direction, a percentage of a distance between the first local minimum value and the second local minimum value with respect to a thickness of the inner spring is 39% or more and 46% or less.

9. The spring assembly according to claim 1, wherein a thickness of the inner spring is 150 μm or more.

10. The spring assembly according to claim 1, wherein
a pitch of the plurality of springs is 100 μm or more and 200 μm or less, and
a maximum value of a width of each spring along the first direction is one-half of the pitch or less.

11. The spring assembly according to claim 1, wherein
the spring assembly comprises a base material including at least one material selected from a group consisting of stainless alloy, beryllium copper, nickel-tin copper, phosphor bronze, Corson alloy, and titanium copper,
the base material is provided with a first surface, and a second surface opposite to the first surface of the base material, and
the spring assembly further comprises a copper layer on at least one of the first surface of the base material and the second surface of the base material.

12. The spring assembly according to claim 4, wherein
a width of the inner spring along the first direction has a local maximum value at the first top portion, the second top portion, or between the first top portion and the second top portion in the second direction.

13. The spring assembly according to claim 2, wherein
in the second direction, the width of the inner spring has a first local minimum value between the first end portion and the first top portion, and has a second local minimum value between the second end portion and the first top portion, and
a percentage of the first local minimum value with respect to the local maximum value and a percentage of the second local minimum value with respect to the local maximum value are each 66% or more.

14. The spring assembly according to claim 2, wherein
in the second direction, the width of the inner spring has a first local minimum value between the first end portion and the first top portion, and has a second local minimum value between the second end portion and the first top portion, and
in the second direction, a percentage of a distance between the local maximum value and the first local minimum value with respect to the thickness of the inner spring and a percentage of a distance between the local maximum value and the second local minimum value with respect to the thickness of the inner spring are each 24% or less.

15. The spring assembly according to claim 2, wherein
in the second direction, the width of the inner spring has a first local minimum value between the first end portion and the first top portion, and has a second local minimum value between the second end portion and the second top portion, and
in the second direction, a percentage of a distance between the first local minimum value and the second local minimum value with respect to a thickness of the inner spring is 39% or more and 46% or less.

16. The spring assembly according to claim 4, wherein
in the second direction, the width of the inner spring has a first local minimum value between the first end portion and the first top portion, and has a second local minimum value between the second end portion and the first top portion, and
a percentage of the first local minimum value with respect to the local maximum value and a percentage of the second local minimum value with respect to the local maximum value are each 66% or more.

17. The spring assembly according to claim 4, wherein
in the second direction, the width of the inner spring has a first local minimum value between the first end portion and the first top portion, and has a second local minimum value between the second end portion and the first top portion, and
in the second direction, a percentage of a distance between the local maximum value and the first local minimum value with respect to the thickness of the inner spring and a percentage of a distance between the local maximum value and the second local minimum value with respect to the thickness of the inner spring are each 24% or less.

18. The spring assembly according to claim 4, wherein
in the second direction, the width of the inner spring has a first local minimum value between the first end portion and the first top portion, and has a second local minimum value between the second end portion and the second top portion, and
in the second direction, a percentage of a distance between the first local minimum value and the second local minimum value with respect to a thickness of the inner spring is 39% or more and 46% or less.

19. A camera module, comprising the spring assembly according to claim 1.

20. An electronic device, comprising the camera module according to claim 19.
